(19) United States
(12) Patent Application Publication
(10) Pub. No.: US 2020/0243882 A1
(43) Pub. Date: Jul. 30, 2020

(54) FUEL TANK FOR A FUEL CELL SYSTEM AND METHOD FOR PRODUCING A FUEL TANK

(71) Applicant: Robert Bosch GmbH, Stuttgart (DE)

(72) Inventors: Georg Helmut Schauer, Ludwigsburg (DE); Angelika Schubert, Ludwigsburg (DE); Thomas Waldenmaier, Freiberg/Neckar (DE); Manfred Bacher-Hoechst, Stuttgart (DE)

(21) Appl. No.: 16/494,395

(22) PCT Filed: Feb. 21, 2018
(86) PCT No.: PCT/EP2018/054218

§ 371 Date: Sep. 16, 2019

(30) Foreign Application Priority Data
Mar. 14, 2017 (DE) 10 2017 204 240.0

(51) Int. Cl. H01M 8/04082; C23C 8/26; C23C 8/22; C21D 3/02; F17C 1/00

(52) U.S. Cl. CPC H01M 8/04216; C23C 8/26; C23C 8/22; C21D 3/02; F17C 1/00; F17C 2270/0184; F17C 2260/053; F17C 2203/0639; F17C 2209/2181; F17C 2203/0619; F17C 2203/0648; F17C 2221/012; F17C 2223/036; F17C 2201/0104

(57) ABSTRACT

The invention relates to a fuel tank (1), in particular a hydrogen tank, for a fuel cell system, having a monolithic base body (10) made of a metal alloy, wherein the base body (10) has a first inner layer (11) having a first inner structure and a second outer layer (12) having a second inner structure, which differs from the first inner structure, and wherein the first inner structure is formed from a metastable austenite and the second inner structure is formed from a martensite.

### BACKGROUND OF THE INVENTION

The present invention relates to a fuel tank, especially a hydrogen tank, as well as a method for producing a fuel tank.

Pressurized gaseous hydrogen is stored, among other things for mobile applications, such as in motor vehicles, typically in carbon fiber tanks with a pressure of 700 bar. These weight-optimized tank systems are cost intensive and expensive in their manufacture. Further research is currently required to develop a storage system made from more cost effective material systems, namely steel. However, pressurized hydrogen causes a degradation of the mechanical properties of mechanically high-strength steels, such as an embrittlement of the material. Because of this, mechanically low-strength austenitic steels are used for hydrogen/steel tank systems in a pressure range of up to 200 bar. But for applications in motor vehicles, a higher pressure of 700 bar is required in the tanks.

### SUMMARY OF THE INVENTION

The present invention provides a fuel tank, especially a hydrogen tank, for a fuel cell system, a method for producing a fuel tank, and a corresponding fuel cell system. Further benefits, features and details of the invention will emerge from the dependent claims, the specification, and the drawings. Features and details which are described in connection with the fuel tank according to the invention naturally also apply in connection with the method according to the invention or the fuel cell system according to the invention and vice versa, so that mutual reference can always be and is always made in regard to the disclosure of the individual aspects of the invention.

The invention provides a fuel tank, especially a hydrogen tank, for a fuel cell system, which is formed from a monolithic base body made from a metal alloy, wherein the base body comprises a first inner layer with a first inner structure and a second outer layer with a second inner structure, different from the first inner structure, and wherein the first inner structure is formed from a metastable austenite and the second inner structure is formed from a martensite.

By a fuel tank in the sense of the invention is meant a tank, especially a hydrogen tank, for a preferably hydrogen-containing fuel for a fuel cell system, withstanding a pressure of at least 300 bar, preferably 600 bar and especially preferably 700 bar. By a monolithic base body in the sense of the invention is meant a base body which is made as a single piece of a continuous material. It may be a cast body, which may also have welded seams, or a welded body, e.g., with pipe and plate elements. The first inner layer and the second outer layer of the base body are produced by a phase transformation or layer formation in the very same monolithic base body, and not for example by gluing or welding of separate bodies to form a multi-part or multilayered body. The fuel tank according to the invention can be used in fuel cell systems both for mobile applications, such as in motor vehicles, and for stationary applications, such as in an emergency power supply and/or a generator or the like.

The idea of the invention is to enable the use of mechanically high-strength steels for pressurized hydrogen storage and at the same time retain the advantageous chemical properties of mechanically low-strength steels on the inside of the fuel tank, such as good resistance to rust and embrittlement under the influence of hydrogen. The invention recognizes that the hydrogen resistance of steels depends critically on their structure. Thus, mechanically high-strength martensitic materials have great vulnerability to hydrogen embrittlement, whereas austenitic steels show almost no hydrogen influence. According to the invention, a monolithic base body is provided which has the stable chemical properties of a metastable austenite on its first inner layer or on an inner wall and the stable mechanical properties of a martensite on a second outer layer or on an outer wall of the base body.

According to the invention, at first a monolithic base body is fabricated from a metastable austenite. In a following nitriding process, nitrogen can be introduced into the inner wall of the fuel tank down to a defined first penetration depth. In a subsequent martensitic transformation, for example by appropriate heat treatment of the base body, the second outer layer of mechanically high-strength steel with a mechanically stable martensitic structure is formed on the outside of the base body. On the inside of the base body there remains the first inner layer with a chemically stable austenitic structure, having a high resistance to the harmful influences of hydrogen, especially a high corrosion resistance. The first inner layer thus serves as a diffusion and permeation barrier for hydrogen to protect the surrounding martensite. This accomplishes a separation of the functions in the two layers. The first inner layer serves as an austenitic diffusion barrier for hydrogen and the second outer layer of the base body serves as a strength-optimized martensitic outer shell for the fuel tank.

Hence, a substantially thin-walled, mechanically high-strength and chemically stable fuel tank can be provided. Metal alloys, such as steels, are cost effective materials. The fuel tank according to the invention thus undergoes a significant weight and cost reduction, especially as compared to traditional tank systems, such as those based on carbon fiber or purely austenitic ones. Furthermore, metal alloys can be easily shaped, so that the configuration and design freedom is enlarged for an optimal packaging in the fuel tank according to the invention.

Furthermore, it may be provided in the context of the invention, in a fuel tank, that the base body has a substantially circular or elliptical cross section, or a substantially square cross section, with rounded corners for example, or a cross section with at least one inwardly curved side wall. The advantage of a substantially circular or elliptical cross section may be the achieving of an improved ratio between surface and volume content. Furthermore, in this way an improved pressure distribution can be accomplished over the surface of the fuel tank, such as a uniform distribution. A fuel tank with a substantially square cross section, in turn, can be better stowed and/or stacked. A fuel tank with a cross section having at least one inwardly curved side wall may provide the benefit that no tensile stresses will be present on the surface of the fuel tank, but only compressive stresses, in the highly stressed regions. In this way, one can provide a fuel tank with high mechanical strength and stability and with a high pressure range.

Furthermore, it may be provided in the context of the invention, in a fuel tank, that the base body, especially the first inner layer, is made from an austenitic steel, preferably with a nickel fraction of 7 to 9% and/or a nitrogen fraction up to 1%. Hence, the range of existence of the austenitic structure, especially in the first inner layer of the base body, can be stabilized and/or expanded.

Furthermore, the invention may provide, in a fuel tank, that the second outer layer is produced by a martensitic transformation on the outside of the base body down to a preferably defined second penetration depth. Hence, a simple processing of the base body can be accomplished, in order to provide a mechanically high-strength outer shell for the fuel tank. By a defined second penetration depth in the sense of the invention can be meant a specifically chosen material thickness of the second outer layer in relation to a total material thickness of the fuel tank for a desired storage density of the fuel tank for a given size of the fuel tank. Thus, for more storage density of the fuel tank a relatively thick second outer layer can be used in order to provide more mechanical strength. For a fuel tank with a relatively low storage density, on the other hand, a relatively thin second outer layer can be used. Moreover, when selecting the second penetration depth in the sense of the invention one may take into account the material properties or the second inner structure of the second outer layer. The second penetration depth in the sense of the invention can be adapted depending on the hardness of the second inner structure.

Furthermore, the invention provides a method for producing a fuel tank, especially a hydrogen tank, for a fuel cell system, which is characterized by the following steps:
a) producing a monolithic base body having a first inner structure made from a metastable austenite,
b) producing a second outer layer having a second inner structure, different from the first inner structure, by a martensitic transformation on the outside of the base body.

The same benefits are achieved as were described above in connection with the fuel tank according to the invention, to which reference is now made to the full extent.

Moreover, a method in the sense of the invention may have at least one further step:

a1) treatment of a first inner layer of the base body by nitriding of the base body from the inside to the outside up to a preferably defined first penetration depth.

Hence, the range of existence of the metastable austenite can be stabilized and/or enlarged, especially in the first inner layer of the base body. Nitriding can be achieved for example by a plasma treatment and/or by an annealing treatment under a nitrogen atmosphere in the interior of the fuel tank. By a defined first penetration depth in the sense of the invention can be meant a specifically chosen material thickness of the first inner layer in relation to a total material thickness of the fuel tank for a desired storage density of the fuel tank for a given size of the fuel tank. Thus, for more storage density of the fuel tank a relatively thick first inner layer can be used in order to provide a greater barrier for the hydrogen up to the second outer layer. For a fuel tank with a relatively low storage density, on the other hand, a relatively thin first inner layer can be used. Moreover, when selecting the first penetration depth in the sense of the invention one may take into account the material properties or the first inner structure of the first inner layer. The more austenite-stabilizing alloy elements contained in the first inner structure, such as nickel, carbon, manganese, nitrogen and cobalt, the less the first penetration depth can be chosen in the sense of the invention.

It is furthermore conceivable to adapt the first penetration depth in the sense of the invention or the material thickness of the first inner layer of the base body and the second penetration depth in the sense of the invention or the material thickness of the second outer layer of the base body as separate adjustment parameters for the desired size and capacity of the fuel tank. In doing so, the first penetration depth and the second penetration depth can be varied proportionately. Furthermore, it is conceivable for the first penetration depth and the second penetration depth to each constitute 50% of the total material thickness of the fuel tank, while the desired size and capacity of the fuel tank can be regulated by variation of the total material thickness of the fuel tank as an adjustment parameter.

Moreover, a method in the sense of the invention may have at least one further step:

a2) treatment of the second outer layer of the base body by denitriding of the base body from the outside to the inside up to a preferably defined second penetration depth.

Hence, the production of the fuel tank can be simplified, while at the same time the separation of the functions on the one hand can ensure a high chemical stability due to the first inner layer and a high mechanical strength due to the second outer layer of the base body. Thus, first of all it is possible to produce a base body with a high fraction of austenite-stabilizing alloy elements, such as one with a nickel fraction of 7 to 9% and/or a nitrogen fraction up to 1%. After this, from the outer surface of the fuel tank without a nitrogen atmosphere so much nitrogen can be removed (denitriding) that under a sufficiently rapid cooldown the second outer layer of the base body is martensitically hardened and the first inner layer of the base body remains austenitic due to the additional nitrogen.

Moreover, a method in the sense of the invention may have at least one further step:

a3) treatment of the second outer layer of the base body by carburizing of the base body from the outside to the inside up to a preferably defined second penetration depth.

Hence, the second outer layer of the base body can be hardened, thereby enhancing the mechanical stability of the fuel tank.

Moreover, a method in the sense of the invention may provide that the base body is produced in step a) by a deep drawing from a single steel plate with austenitic properties. In this way, the method for producing the fuel tank can be advantageously simplified. Furthermore, it is conceivable for the base body to be produced with different circular, elliptical, polygonal cross sections, preferably with at least one inwardly curved side wall. After this, the base body may be treated from the outside, in order to obtain the second outer layer with martensitic properties. Moreover, a cover may be provided, which can close off the base body hermetically, and the cover may be fastened to the base body by integral bonding and/or force locking and/or form fitting. Advantageously, sensors and/or valves and/or a control device for controlling and/or regulating the pressure in the fuel tank and/or the fuel dispensing from the fuel tank may be arranged on the cover.

Furthermore, it may be provided in a method in the context of the invention that at least one desired pressure in the fuel tank or a desired size of the fuel tank is taken into account in step a). This may be facilitated advantageously by the choice of the materials or inner structures of the first inner layer and the second outer layer, which may have specific technical and chemical properties. Hence, an improved fuel tank can be provided, made of favorable materials and with little expense.

Furthermore, at least one material thickness of the fuel tank, a first inner layer or a second outer layer of the base body may be chosen in dependence on a desired pressure in the fuel tank or a desired size of the fuel tank. Hence, a fuel tank may be provided for a broad range of different applications, which can be easily adapted to different requirements of the different applications.

Moreover, in the context of the invention a corresponding fuel cell system is provided for mobile applications, such as in motor vehicles, being designed with a fuel tank produced with the aid of the above described method. The same benefits are achieved here as were described above in connection with the fuel tank according to the invention or the method according to the invention for producing the fuel tank, to which reference is made to the full extent.

The invention also relates to a motor vehicle having at least one fuel tank according to the invention.

### BRIEF DESCRIPTION OF THE DRAWINGS

The filter system according to the invention and its modifications as well as its benefits and the method according to the invention and its modifications as well as its benefits shall be explained more closely below with the aid of drawings. There are shown each time schematically:

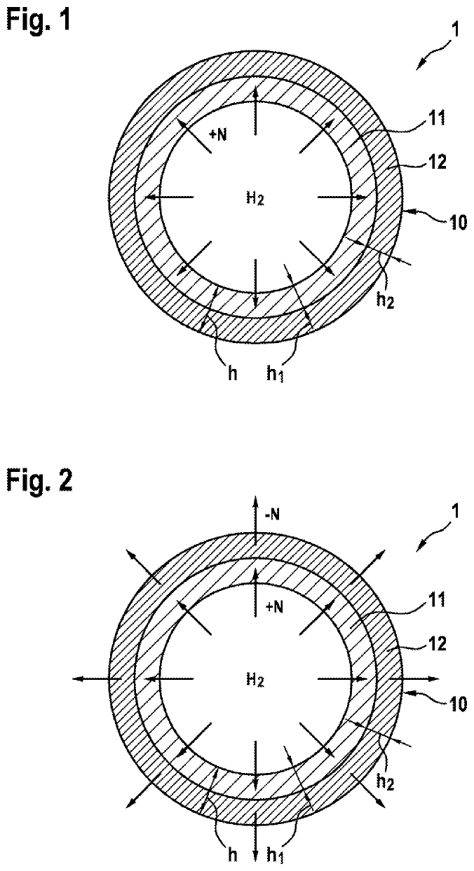

in FIG. 1, a schematic representation of a fuel tank according to the invention,

in FIG. 2, a further schematic representation of a fuel tank according to the invention, and

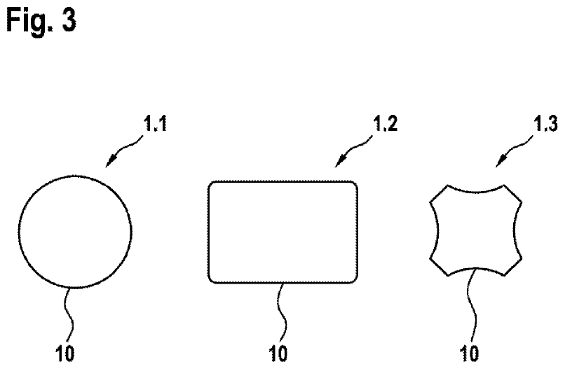

in FIG. 3, different geometries of a fuel tank according to the invention.

In the different figures, the same parts of the fuel tank 1 are always given the same reference numbers, so that in general they will only be described once.

### DETAILED DESCRIPTION

FIGS. 1 and 2 show a fuel tank 1 for a fuel cell system, which is not represented in the interests of simplicity. The fuel tank 1 can be used in fuel cell systems both for mobile applications, such as in motor vehicles, and for stationary applications, such as in emergency power supply and/or a generator or the like.

The fuel tank 1 is formed with a monolithic base body 10 made from a metal alloy, wherein the base body 10 comprises a first inner layer 11 with a first inner structure and a second outer layer 12 with a second inner structure, different from the first inner structure, and wherein the first inner structure is formed from a metastable austenite and the second inner structure is formed from a martensite.

By a fuel tank 1 in the sense of the invention can be meant a hydrogen tank or a tank for a hydrogen-containing fuel. The monolithic base body 10 in the sense of the invention is made as a single piece of a continuous material. The first inner layer 11 and the second outer layer 12 of the base body 10 are produced here by a phase transformation or layer formation in the very same monolithic base body 10, and not for example by gluing or welding of separate bodies to form a multi-part or multilayered body.

The invention is based on the knowledge that the hydrogen resistance of steels depends critically on the inner structure. Thus, mechanically high-strength martensitic materials have great vulnerability to hydrogen embrittlement, whereas austenitic steels exhibit almost no hydrogen influence.

According to the invention, at first in step a) a monolithic base body 10 is fabricated from a metastable austenite. In a following optional nitriding process in step a1), nitrogen N can be introduced into the inner wall of the fuel tank 1 down to a defined first penetration depth h1. In a subsequent martensitic transformation, for example by appropriate heat treatment of the base body 10, the second outer layer 12 of mechanically high-strength steel with a mechanically stable martensitic structure is formed on the outside of the base body 10. On the inside of the base body 10 there remains the first inner layer 11 with a chemically stable austenitic structure, having a high resistance to the harmful influences of hydrogen, especially a high corrosion resistance. The first inner layer 11 thus serves as a diffusion and permeation barrier for hydrogen H2 to protect the surrounding martensite in the second outer layer 12. This accomplishes a separation of the functions in the two layers 11, 12. The first inner layer 11 serves as an austenitic diffusion barrier for hydrogen H2 and the second outer layer 12 of the base body 10 serves as a strength-optimized martensitic outer shell for the fuel tank 1.

Hence, a weight-optimized, cost effective, mechanically high-strength and chemically stable fuel tank 1 can be provided, which is easy to fabricate. Moreover, metal alloys can be easily shaped, for example by drawing, so that the configuration and design freedom is enlarged for an optimal packaging in the fuel tank 1 according to the invention.

The first inner layer 11 of the base body 10 can be produced from an alloy which is enriched with austenite-stabilizing alloy elements, such as nickel, carbon, manganese, nitrogen and cobalt, preferably with a nickel fraction of 7 to 9% and/or a nitrogen fraction of up to 1%.

As indicated by FIG. 1, the first inner layer 11 of the base body 10 can take up so much additional nitrogen N inside the fuel tank 1 by an annealing treatment under a nitrogen atmosphere in the interior of the fuel tank 1 (nitriding, optional step (a1)) that its austenitic properties are stabilized and/or enlarged over a broad temperature range, such as from −70° C. to +150° C. The nitriding can occur from the inside to the outside as far as a preferably defined or adjustably regulated first penetration depth h1.

As further indicated by FIG. 2, the second outer layer 12 of the base body 10 can give off so much nitrogen N on the outer surface of the fuel tank 1 without a nitrogen atmosphere (denitriding, optional step (a2)) and/or take up so much carbon K by a carbon donor gas (carburizing, optional step (a3)) that, under a sufficiently rapid cooldown, the outer region of the fuel tank 1 is martensitically hardened and the inner region of the fuel tank 1 remains austenitic due to the additional nitrogen N. The denitriding and/or carburizing may be achieved from the outside to the inside as far as a preferably defined or adjustably regulated second penetration depth h2.

As further indicated by FIG. 3, the invention may provide for a fuel tank 1 that the base body 10 can be produced with different cross sections. This is advantageously possible in that the base body 10 is made from a malleable material, such as a metal alloy, for example by deep drawing. Different cross sections are conceivable, such as a substantially circular or elliptical cross section 1.1, shown on the left in FIG. 3, or a substantially square cross section 1.2, for example with rounded corners, shown in the middle of FIG. 3, or a cross section 1.3 with at least one inwardly curved side wall, shown on the right in FIG. 3. The advantage of a substantially circular or elliptical cross section 1.1 may be the resultant achieving of an improved ratio between surface and volume content of the fuel tank 1. Furthermore, in this way an improved pressure distribution can be accomplished over the surface of the fuel tank 1, such as a uniform distribution. A fuel tank 1 with a substantially square cross section 1.2, in turn, can be better stowed and/or stacked. A fuel tank 1 with a cross section 1.3 having at least one inwardly curved side wall may provide the benefit that no tensile stresses will be present, but only compressive stresses, in the highly stressed regions of the fuel tank 1. In this way, the mechanical strength of the fuel tank 1 can be increased.

The preceding description of FIGS. 1 to 3 describes the present invention solely in the context of examples. Of course, individual features of the embodiments, so far as is technically meaningful, may be combined with each other at will, without leaving the scope of the invention.

Furthermore, it is conceivable when producing the base body 10 in step a) to employ different proven methods for the mechanical forming of steel plates, such as deep drawing, rolling, or the like, which may further simplify the production of the fuel tank 1.

Furthermore, at least the total material thickness h of the fuel tank 1, or the first penetration depth h1 or the material thickness of the first inner layer 11 or the second penetration depth h2 or the material thickness of the second outer layer 12 of the base body 10 can be adjusted in dependence on a desired pressure in the fuel tank 1 or a desired size of the fuel tank 1. The first penetration depth h1 and the second penetration depth 2 may be adjusted individually, in order to adapt different properties of the fuel tank 1 in a flexible manner. Alternatively, it is conceivable that a ratio of 1 to 1, especially 50% each of the total material thickness h of the fuel tank 1, may be advantageous for the first penetration depth h1 and the second penetration depth 2 in order to be able to adjust the desired properties of the fuel tank 1 easily through the choice of a suitable total material thickness h of the fuel tank 1.

1. A fuel tank (1) for a fuel cell system, the fuel tank having a monolithic base body (10) made from a metal alloy, wherein the base body (10) comprises a first inner layer (11) with a first inner structure and a second outer layer (12) with a second inner structure, different from the first inner structure, and wherein the first inner structure is formed from a metastable austenite and the second inner structure is formed from a martensite.

2. The fuel tank (1) as claimed in claim 1, characterized in that the base body (10) has a substantially circular or elliptical cross section (1.1), or a substantially square cross section (1.2), or a cross section (1.3) with at least one inwardly curved side wall.

3. The fuel tank (1) as claimed in claim 1, characterized in that the base body (10) is made from an austenitic steel.

4. A method for producing a fuel tank (1) for a fuel cell system, the method comprising the following steps:
a) producing a monolithic base body (10) having a first inner structure made from a metastable austenite, and
b) producing a second outer layer (12) having a second inner structure, different from the first inner structure, by a martensitic transformation on the outside of the base body (10).

5. The method as claimed in claim 4, characterized in that the method involves at least one further step:
a1) treatment of a first inner layer (11) of the base body (10) by nitriding of the base body (10) from an inside to an outside.

6. The method as claimed in claim 4, characterized in that the method involves at least one further step:
a2) treatment of the second outer layer (12) of the base body (10) by denitriding of the base body (10) from an outside to an inside.

7. The method as claimed in claim 4, characterized in that the method involves at least one further step:
a3) treatment of the second outer layer (12) of the base body (10) by carburizing of the base body (10) from an outside to an inside.

8. The method as claimed in claim 4, characterized in that the base body (10) is produced in step a) by a deep drawing.

9. The method as claimed in claim 4, characterized in that at least one desired pressure in the fuel tank (1) or a desired size of the fuel tank (1) is taken into account in step a).

10. (canceled)

11. The fuel tank (1) as claimed in claim 1, characterized in that the first inner layer (11) is made from an austenitic steel.

12. The fuel tank (1) as claimed in claim 11, wherein the second outer layer (12) is produced by a martensitic transformation on an outside of the base body (10).

13. The fuel tank (1) as claimed in claim 1, characterized in that the first inner layer (11) is made from an austenitic steel with a nickel fraction of 7 to 9% and/or a nitrogen fraction up to 1%, wherein the second outer layer (12) is produced by a martensitic transformation on the outside of the base body (10) down to a defined second penetration depth (h2).

14. The method as claimed in claim 4, characterized in that the method involves at least one further step:
a1) treatment of a first inner layer (11) of the base body (10) by nitriding of the base body (10) from an inside to an outside up to a defined first penetration depth (h1).

15. The method as claimed in claim 4, characterized in that the method involves at least one further step:
a2) treatment of the second outer layer (12) of the base body (10) by denitriding of the base body (10) from an outside to an inside up to a defined second penetration depth (h2).

16. The method as claimed in claim 4, characterized in that the method involves at least one further step:
a3) treatment of the second outer layer (12) of the base body (10) by carburizing of the base body (10) from an outside to an inside up to a defined second penetration depth (h2).

17. The method as claimed in claim 4, characterized in that at least one desired pressure in the fuel tank (1) or a desired size of the fuel tank (1) is taken into account in step a), wherein at least one material thickness of the fuel tank (1), a first inner layer (11) or a second outer layer (12) of the base body (10) is chosen in dependence on a desired pressure in the fuel tank (1) or a desired size of the fuel tank (1).

18. The fuel tank (1) as claimed in claim 1, characterized in that the base body (10) has a substantially circular or elliptical cross section (1.1).

19. The fuel tank (1) as claimed in claim 1, characterized in that the base body (10) has a substantially square cross section (1.2).

20. The fuel tank (1) as claimed in claim 1, characterized in that the base body (10) has a cross section (1.3) with at least one inwardly curved side wall.
